(19) United States
(12) Patent Application Publication
(10) Pub. No.: US 2019/0124917 A1
(43) Pub. Date: May 2, 2019

(54) MICROBIAL INOCULANT COMPOSITIONS AND USES THEREOF

(71) Applicant: Koch Agronomic Services, LLC, Wichita, KS (US)

(72) Inventor: Drew R. Bobeck, Wichita, KS (US)

(73) Assignee: Koch Agronomic Services, LLC, Wichita, KS (US)

(21) Appl. No.: 16/095,157

(22) PCT Filed: Apr. 20, 2017
(86) PCT No.: PCT/US2017/028516

§ 371 Date: Oct. 19, 2018

Related U.S. Application Data
(60) Provisional application No. 62/325,713, filed on Apr. 21, 2016.

(51) Int. Cl. A01N 25/28; A01N 63/02; A01N 63/04; C05C 11/00; C05C 7/00; C05C 9/00; C05G 3/08; A01N 57/28; A01N 33/26

(52) U.S. Cl. CPC A01N 25/28; A01N 63/02; A01N 63/04; C05C 11/00; A01N 33/26; C05C 9/005; C05G 3/08; A01N 57/28; C05C 7/00

(57) ABSTRACT

The present invention provides novel microbial inoculant compositions for uses in promoting plant growth, plant productivity and/or soil quality. The novel microbial inoculant compositions comprise one or more microbial species, one or more urease inhibitors and/or nitrification inhibitors. The present invention also provides fertilizer compositions comprising said microbial inoculant compositions.

### CROSS REFERENCE TO RELATED APPLICATIONS

This present application claims priority to U.S. Provisional Patent Application No. 62/325,713 filed Apr. 21, 2016 the disclosures of which are incorporated by reference herein.

### TECHNICAL FIELD

The present invention relates to novel microbial inoculant compositions for uses in promoting plant growth, plant productivity and/or soil quality. The novel microbial inoculant compositions comprise one or more microbial species, one or more urease inhibitors and/or nitrification inhibitors. The present invention also relates to fertilizer compositions comprising said microbial inoculant compositions, formulations and the uses thereof.

### BACKGROUND

The use of fertilizers to enhance plant and crop production and overcome poor soil quality is widespread. Most commonly employed commercially available nitrogen containing fertilizers are inorganic chemical fertilizers such as urea. The extended use of urea is often associated with negative environmental consequences, such as nitrate contamination in run off and ground water, and emission of ammonia and nitrous oxide to the atmosphere. Attention to nitrogen fertilizer application has shifted from the role of promoting crop production to environmental pollution. There are a variety of new management practices and technologies that can promote nitrogen use efficiency and alleviate environmental pollution.

One of the widely used technologies is the application of a urease inhibitor in combination with the urea treatment. The urea component of fertilizer applied to the soil becomes a source of ammonia as a result of urease catalyzed hydrolysis of urea, an enzyme produced by numerous fungi and bacteria that is well known to skilled artisans. Urease inhibitors can slow down the conversion rate of urea to ammonia, thereby significantly reducing the quantity of urea that otherwise has to be applied on the soil by reducing the amount of ammonia volatilization. One of the most common urease inhibitors is N-(n-butyl) thiophosphoric triamide (NBPT) (See e.g. U.S. Pat. No. 5,698,003).

Another widely used technology is the application of nitrification inhibitors to significantly reduce nitrate leaching and gaseous nitrogen emissions. Most nitrogen supplied as a commercial fertilizer is ultimately transformed to a nitrate form of nitrogen. In the presence of adequate oxygen, warm temperatures, and some moisture, ammonium-N is converted to nitrate-N through a biochemical process known as nitrification that requires two forms of soil bacteria. The first bacterium Nitrosomonas converts ammonium-N to nitrite-N. The second bacterium Nitrobacter converts nitrite-N to nitrate-N. Nitrification inhibitors have one primary way of delaying the nitrification process by inhibiting the bacteria Nitrosomonas in the area where ammonium is to be present. Some widely used nitrification inhibitors that are commercially available include 2-chloro-6-(trichloromethyl)-pyridine (Nitrapyrin) and dicyandiamide (DCD).

In addition to the application of chemical enzyme inhibitors such as urease inhibitor N-(n-butyl) thiophosphoric triamide (NBPT) and nitrification inhibitors such as dicyandiamide (DCD), fertilizer compositions comprising microorganisms (so-called “bio-fertilizers” or “bio-stimulants”) are increasingly considered as alternatives to conventional chemical fertilizers. The ability of specific bacterial species to promote plant growth has long been recognized. For example, nitrogen-fixing bacteria such as Rhizobium species provide plants with essential nitrogenous compounds. Species of Azotobacter and Azospirillum have also been shown to promote plant growth and increase crop yield, promoting the accumulation of nutrients in plants. However bacteria of these genera are often unable to compete effectively with native soil and plant flora, thereby requiring the application of impractically large volumes of inoculum.

### SUMMARY OF THE INVENTION

To date, urease inhibitors and nitrification inhibitors have met with varied success, while bio-fertilizers have typically met with limited success. Thus, there remains a need for improved fertilizers or fertilizer additives and methods that are effective in providing nutrients for plant growth and are environmentally safe and non-hazardous. One solution is to provide a combination of urease inhibitors and/or nitrification inhibitors with bio-fertilizers. Nevertheless, the combination of urease inhibitors and/or nitrification inhibitors with bio-fertilizers is not straight forward. First, urease inhibitors and/or nitrification inhibitors can weaken or kill the bio-fertilizers when combined. Second, urease inhibitors and/or nitrification inhibitors are typically dispensed in a solvent system (e.g. glycol, complex amines, aryl alcohols), which can also weaken or kill the bio-fertilizers.

In one broad embodiment, the present invention provides a microbial inoculant composition comprising at least one microbial strain from one or more microbial species, and at least one active agent, wherein the active agent is a urease inhibitor or a nitrification inhibitor or a combination thereof, and further wherein at least one microbial strain is present at an effective amount to promote plant health, plant nutrition, and/or soil health in the presence of the active agent.

In another embodiment, the present invention provides a method of enhancing a yield trait in a subject plant as compared to the yield trait of a reference or control plant is disclosed, the method comprising contacting an effective amount of a microbial inoculant composition to the reference plant, plant part, plant seed, or surrounding soil, wherein the microbial inoculant composition comprises:
i. at least one microbial strain from one or more microbial species, and
ii. at least one active agent, wherein the active agent is a urease inhibitor, nitrification inhibitor, or a combination thereof,
wherein the microbial inoculant composition at the effective amount is effective in enhancing the yield trait in the subject plant relative to the yield trait in the reference or control plant when the subject plant is contacted with the effective amount.

The urease inhibitor or nitrification inhibitor can mitigate nitrate contamination in run off and ground water, and the emission of large amount of ammonia and nitrous oxide to the atmosphere. The microbial species can further promote plant health, plant nutrition, and soil health. The combination of both chemical enzyme inhibitors and microbial species in suitable compositions and formulations may serve a better approach to improve the efficiency of nitrogen-based fertilizer usage, plant productivity, soil quality, and the overall environmental sustainability.

### DETAILED DESCRIPTION OF THE INVENTION

Unless defined otherwise, all technical and scientific terms used herein have the same meaning as commonly understood by those of ordinary skill in the art.

In one embodiment, the present invention provides a microbial inoculant composition comprising at least one microbial strain from one or more microbial species, and at least one active agent, wherein the active agent is a urease inhibitor or a nitrification inhibitor or a combination thereof, and further wherein the at least one microbial strain promotes plant health, plant nutrition, and/or soil health in the presence of the active agent.

In another embodiment, the present invention provides a microbial inoculant composition comprising at least one microbial strain from one or more microbial species, and at least one active agent, wherein the active agent is a urease inhibitor or a nitrification inhibitor or a combination thereof, further wherein the at least one microbial strain promotes plant health, plant nutrition, and/or soil health in the presence of the active agent, wherein one or more microbial species are selected from the following group:
(1) Spore forming species of bacteria;
(2) Spore forming species of fungi;
(3) Mycorrhizal organisms including Laccaria bicolor, Glomus intraradices, and Amanita species;
(4) Actinomyces species and strains thereof, including Streptomyces lydicus, Streptomyces griseoviridis, Streptomyces griseoviridis

K61 (Mycostop; AgBio development), Streptomyces microflavus AQ 6121;
(5) Bacillus species and strains thereof, including: Bacillus itcheniformis; Bacillus megaterium; Bacillus pumilus, Bacillus amyloliquefaciens, Bacillus licheniformis; Bacillus oleronius; Bacillus megaterium; Bacillus mojavensis; Bacillus pumilus; Bacillus subtilis; Bacillus circulans; Bacillus globisporus; Bacillus firmus, Bacillus thuringiensis, Bacillus cereus, Bacillus amyloliquefaciens strain D747 (Double Nickel; Certis), Bacillus firmus strain 1-1582 (Votivo and Nortica; Bayer), Bacillus licheniformis, Bacillus licheniformis strain SB3086 (EcoGuard; Novozymes), Bacillus pumilus strain GB34 (YieldShield; Bayer), QST2808 (Sonata; Bayer), Bacillus subtilis strains GB03 (Kodiak; Bayer), MBI 600 (Subtilex; Becker Underwood) & QST 713 (Serenade; Bayer), Bacillus subtilis strain GB122 plus Bacillus amyloliquefaciens strain GB99 (BioYield; Bayer), Bacillus pumilus strain BU F-33, Bacillus thuringiensis galleriae strain SDS-502, Bacillus thuringiensis kurstaki, VBTS 2546, Bacillus cereus BP01, Bacillus subtilis strain EB120, Bacillus subtilis strain J-P13, Bacillus subtilis FB17, Bacillus subtilis strains QST30002 and QST3004 (NRRL B-50421 and NRRLB-50455), Bacillus subtilis strains QST30002 and QST3004 (NRRL B-50421 and NRRLB-50455) sandpaper mutants, Bacillus thuringiensis subsp kurstaki strain VBTS 2477 quadruple enterotoxindeficient mutants, Bacillus simplex strains 03WN13, 03WN23 and 03WN25, Bacillus subtilis strain QST 713, Bacillus mycoides isolate BmJ NRRL B-30890, Bacillus subtilis strain DSM 17231 and B licheniformis strain DSM17236, Bacillus aryabhattai, B. flexus, B. nealsonii, Bacillus sphaericus, Bacillus megaterium, B. vallismortis, B. methylotrophicus, B. atrophaeus, B. amyloliquefasciens, Bacillus subtilis strain KAS-001, Bacillus methylotrophicus strain KAS-002, Bacillus vallismortis strain KAS-003, Bacillus atrophaeus strain KAS-004, Bacillus methylotrophicus strain KAS-005, Bacillus subtilis strain KAS-006, Bacillus amyloliquefasciens strain KAS-007, Bacillus methylotrophicus strain KAS-008, Bacillus subtilis strain KAS-009, Bacillus subtilis strain KAS-010, Bacillus subtilis strain KAS-011, Bacillus methylotrophicus strain KAS-012, Bacillus methylotrophicus strain KAS-013, Bacillus methylotrophicus strain KAS-014;

(6) Species of “Plant Growth Promoting Rhizobacteria” (PGPRs) and strains thereof, including species reported to be capable of Nitrogen fixation, for example Gluconacetobacter species (e.g. Gluconacetobacter diazotrophicus a.k.a. Acetobacter diazotrophicus), Spirillum species (e.g. Spirillum lipoferum), Azospirillum species, Herbaspirillum seropedicae, Azoarcus species, Azotobacter species, Burkholderia species, Burkholderia sp. A396, Paenibacillus polymyxa;

(7) N-fixing bacterial species and strains thereof, including Rhizobium species (e.g. Bradyrhizobium species such as Bradyrhizobium japonicum, Rhizobium meliloti);

(8) Microbial species and strains thereof that are known to improve nutrient use efficiency, including Penicillium species (e.g. Penicillium bilaii, Penicillium bilaji), Mesorhizobium cicero;

(9) Microbial species and strains thereof that are known to have insecticidal or insect repellent effects including Telenomus podisi, Baculovirus anticarsia; Trichogramma pretiosum, Trichogramma galloi, Chromobacterium subtsugae, Trichoderma fertile JM41R, Beauveria bassiana, Beauveria bassiana strain NRRL 30976, Beauveria bassiana strain ATP02, DSM 24665, Paecilomyces fumosoroseus, Trichoderma harzianum, Verticillium lecanii, Isaria fumosorosea CCM 8367 (CCEFO.011.PFR), Lecanicillium muscarium, Streptomyces microflavus, Muscodor albus;

(10) Microbial species and strains thereof that are known to have nematicidal effects e.g. Myrothecium verrucaria, Pasteuria species and strains thereof including Pasteuria nishizawae, Pasteuria reneformis strain Pr-3, Paecilomyces lilacinus, Chromobacterium subtsugae, Pasteuria strain ATCC SD-5832, Metarhizium species, Flavobacterium species;

(11) Microbial species and strains thereof that are known to have antifungal, antimicrobial and/or plant growth promoting effects e.g. Gliocladium species, Pseudomonas species (e.g. Pseudomonas fluorescens, Pseudomonas fluorescens D7, P. putida and P. chlororaphis), Pseudomonas fluorescens strain NRRL B-21133, NRRL B-21053 or NRRL B-21102, Pseudomonas fluorescens VPS, Pseudomonas synxantha, Pseudomonas diazotrophicus, Enterobacter cloacae strain NRRL B-21050, Trichoderma species, Trichoderma virens, Trichoderma atroviride strains, Coniothyrium minitans, Gliocladium species, Gliocladium virens, Gliocladium roseum strain 321U, Trichoderma harzianum species, Trichoderma harzianum Rifai, Clonostachys rosea strain 88-710, Pseudomonas rhodesiae FERM BP-10912, Serratia plymuthica CCGG2742, Cryptococcus lavescens strain OH 182.9, Serratia plymuthica, Cladosporium cladosporioides, Mitsuaria species, Coprinus curtus, Virgibacillus halophilus, Saccharomyces species, Metschnikovia fruticola, Candida oleophila, Acremonium species, Pseudozyma aphidis, Pythium oligandrum, Phoma spp strain 1-4278, Achromobacter species, Geomyces species, Pseudomonas azotoformans, strain F30A, Brevibacillus parabrevis strain No 4; non-toxigenic Aspergillus strains NRRL 50427, NRRL 50428, NRRL 50429, NRRL 50430 and NRRL 50431, Sphaerodes mycoparasitica strains IDAC 301008-01, -02, or -03, Muscodor albus strain NRRL 30547 or NRRL30548, Serratia plymuthica CCGG2742, Pseudomonas koreensis strain 101L21, P lini strain 131L01, Pantoea agglomerans strain 101L31, Streptomyces scopuliridis strain RB72, Acremonium spp endophytes, Streptomyces spp BG76 strain, Paracoccus kondratievae, Enterobacter cloacae, Cryptococcus flavescens, Lactobacillus parafarraginis, Lactobacillus buchneri, Lactobacillus rapi or Lactobacillus zeae, Paenibacillus polymyxa, Serratia plymuthica, Phoma species, Pythium oligandrum, Mycosphaerella species, Variovorax species;

(12) Bacterial species and strains thereof from the group termed Pink-Pigmented Facultative Methylotrophs (PPFMs) including Methylobacterium species; and

(13) Microbial species and strains thereof that are known to have herbicidal effects e.g. Pyrenophora semeniperda;

wherein the urease inhibitor is selected from a group consisted of N-(n-butyl)thiophosphoric triamide (NBPT), N-(n-butyl)phosphoric triamide, thiophosphoryl triamide, phenyl phosphorodiamidate, cyclohexyl phosphoric triamide, cyclohexyl thiophosphoric triamide, phosphoric triamide, hydroquinone, p-benzoquinone, hexamidocyclotriphosphazene, thiopyridines, thiopyrimidines, thiopyridine-N-oxides, N,N-dihalo-2-imidazolidinone, N-halo-2-oxazolidinone, N-(2-nitrophenyl)thiophosphoric triamide, N-(2-nitrophenyl)phosphoric triamide, derivatives thereof, or any combination thereof; and
wherein the nitrification inhibitor is selected from a group consisted of 2-chloro-6-trichloromethylpyridine, 5-ethoxy-3-trichloromethyl-1,2,4-thiadiazol, dicyandiamide, 2-amino-4-chloro-6-methyl-pyrimidine, 1,3-benzothyiazole-2-thiol, 4-amino-N-1,3-thiazol-2-ylbenzene sulfonamide, thiourea, guanidine, 3,4-dimethylpyrazole phosphate, 2,4-diamino-6-trichloromethyl-5-triazine, poly etherionophores, 4-amino-1,2,4-triazole, 3-mercapto-1,2,4-triazole, potassium azide, carbon bisulfide, sodium trithiocarbonate, ammonium dithiocarbamate, 2,3,-dihydro-2,2-dimethyl-7-benzofuranol methylcarbamate, N-(2,6-dimethylphenyl)-N-(methoxyacetyl)-alanine methyl ester, ammonium thiosulfate, 1-hydroxypyrazole, 3-methylpyrazole-1-carboxamide, 3-methylpyrazole, 3,5-dimethylpyrazole, 1,2,4-triazole, G77 Nitrification Inhibitor (or an equivalent composition according to CAS Registration No. 1373256-33-7, such as compositions disclosed in the United States Patent Publication No. 20110296886 A1, and the United States Patent Publication No. 20160060184 A1, which are herein incorporated by reference), derivatives thereof, and any combination thereof.

In one embodiment, the present invention provides a carrier-based formulation for any microbial inoculant composition of the present invention, wherein the carrier is selected from peat, charcoal, soil mixture, vermiculite, perlite, bentonite, compost, agro-industrial residues, clays, or urea-formaldehyde polymers.

In one embodiment, the present invention provides a solvent-based formulation for any microbial inoculant composition of the present invention, wherein the solvent is selected from alkanolamines such as triethanolamine, diethanolamine, monoethanolamine; alkyldiethanolamines, dialkylmonoethanolamines, wherein the alkyl group is C₁-C₂₄ branched or unbranched alkyl chain; dimethylsulfoxide (DMSO); alkylsulfones such as sulfolane {2,3,4,5-tetrahydrothiophene-1,1-dioxide); alkyl amides such as N-methylpyrrolidone, M-ethylpyrrolidone, or dimethylformamide; monoalcohols such as methanol, ethanol, propanol, isopropanol, or benzyl alcohol; glycols such as ethylene glycol, propylene glycol, diethylene glycol, or dipropylene glycol; glycol derivatives and protected glycols; glycerol and glycerol derivatives (trialcohols) including protected glycerols such as isopropylidine glycerol; dibasic esters and derivatives thereof; alkylene carbonates such as ethylene carbonate or propylene carbonate; monobasic esters such as ethyl lactate or ethyl acetate; polymers of carboxylic acids such as maleic acid, oleic acid, itaconic acid, acrylic acid, or methacrylic acid; monoalkyl glycol ethers and dialkyl glycol ethers; glycol esters; surfactants such as alkylbenzenesulfonates, lignin sulfonates, alkylphenol ethoxylates, or polyethoxylated amines.

In one embodiment, the present invention provides an encapsulated formulation for any microbial inoculant composition of the present invention. In the soil environment, inoculated microbial species can find survival difficult among naturally occurring competitor and predator organisms. To aid in survival of microorganisms present in microbial inoculants and fertilizer compositions of the present disclosure upon application in the environment, one or more of the microbial species strains may be encapsulated in, for example, a suitable polymeric matrix. In one example, encapsulation may comprise alginate beads such as has been described by Young et al, 2006, Encapsulation of plant growth-promoting bacteria in alginate beads enriched with humid acid, Biotechnology and Bioengineering 95:76-83. Those skilled in the art will appreciate that any suitable encapsulation material or matrix may be used. Encapsulation may be achieved using methods and techniques known to those skilled in the art. Encapsulated microorganisms can include nutrients or other components of the inoculant or fertilizer composition in addition to the microorganisms.

In one embodiment, the present disclosure provides a microbial inoculant composition comprising:
i. a urease inhibitor selected from the group consisted of N-(n-butyl)thiophosphoric triamide (NBPT), N-(n-butyl)phosphoric triamide, thiophosphoryl triamide, phenyl phosphorodiamidate, cyclohexyl phosphoric triamide, cyclohexyl thiophosphoric triamide, phosphoric triamide, hydroquinone, p-benzoquinone, hexamidocyclotriphosphazene,thiopyridines, thiopyrimidines, thiopyridine-N-oxides, N,N-dihalo-2-imidazolidinone, N-halo-2-oxazolidinone, N-(2-nitrophenyl)thiophosphoric triamide, N-(2-nitrophenyl)phosphoric triamide, derivatives thereof, and any combination thereof;
ii. at least one Bacillus strain selected from the group consisting of Bacillus subtilis strain KAS-001, Bacillus methylotrophicus strain KAS-002, Bacillus vallismortis strain KAS-003, Bacillus atrophaeus strain KAS-004, Bacillus methylotrophicus strain KAS-005, Bacillus subtilis strain KAS-006, Bacillus amyloliquefasciens strain KAS-007, Bacillus methylotrophicus strain KAS-008, Bacillus subtilis strain KAS-009, Bacillus subtilis strain KAS-010, Bacillus subtilis strain KAS-011, Bacillus methylotrophicus strain KAS-012, Bacillus methylotrophicus strain KAS-013, and Bacillus methylotrophicus strain KAS-014; and
iii. an optional solvent selected from the group consisting of N-methylpyrrolidone, propylene glycol, triethylene glycol monobutyl ether, and any combination thereof.

In one embodiment, the present disclosure provides a microbial inoculant composition comprising:
i. N-(n-butyl)thiophosphoric triamide (NBPT);
ii. at least one Bacillus strain selected from the group consisting of Bacillus subtilis strain KAS-001, Bacillus methylotrophicus strain KAS-002, Bacillus vallismortis strain KAS-003, Bacillus atrophaeus strain KAS-004, Bacillus methylotrophicus strain KAS-005, Bacillus subtilis strain KAS-006, Bacillus amyloliquefasciens strain KAS-007, Bacillus methylotrophicus strain KAS-008, Bacillus subtilis strain KAS-009, Bacillus subtilis strain KAS-010, Bacillus subtilis strain KAS-011, Bacillus methylotrophicus strain KAS-012, Bacillus methylotrophicus strain KAS-013, and Bacillus methylotrophicus strain KAS-014; and
iii. a solvent selected from the group consisting of N-methylpyrrolidone, propylene glycol, triethylene glycol monobutyl ether, and any combination thereof.

In one embodiment, the present disclosure provides a microbial inoculant composition comprising:
i. a nitrification inhibitor selected from the group consisting of 2-chloro-6-trichloromethylpyridine, 5-ethoxy-3-trichloromethyl-1,2,4-thiadiazol, dicyandiamide, 2-amino-4-chloro-6-methyl-pyrimidine, 1,3-benzothyiazole-2-thiol, 4-amino-N-1,3-thiazol-2-ylbenzene sulfonamide, thiourea, guanidine, 3,4-dimethylpyrazole phosphate, 2,4-diamino-6-trichloromethyl-5-triazine, poly etherionophores, 4-amino-1,2,4-triazole, 3-mercapto-1,2,4-triazole, potassium azide, carbon bisulfide, sodium trithiocarbonate, ammonium dithiocarbamate, 2,3,-dihydro-2,2-dimethyl-7-benzofuranol methylcarbamate, N-(2,6-dimethylphenyl)-N-(methoxyacetyl)-alanine methyl ester, ammonium thiosulfate, 1-hydroxypyrazole, 3-methylpyrazole-l-carboxamide, 3-methylpyrazole, 3,5-dimethylpyrazole, 1,2,4-triazole, G77 Nitrification Inhibitor (or an equivalent composition according to CAS Registration No. 1373256-33-7, such as compositions disclosed in the United States Patent Publication No. 20110296886 A1, and the United States Patent Publication No. 20160060184 A1), derivatives thereof, and any combination thereof; and
ii. at least one Bacillus strain selected from the group consisting of Bacillus subtilis strain KAS-001, Bacillus methylotrophicus strain KAS-002, Bacillus vallismortis strain KAS-003, Bacillus atrophaeus strain KAS-004, Bacillus methylotrophicus strain KAS-005, Bacillus subtilis strain KAS-006, Bacillus amyloliquefasciens strain KAS-007, Bacillus methylotrophicus strain KAS-008, Bacillus subtilis strain KAS-009, Bacillus subtilis strain KAS-010, Bacillus subtilis strain KAS-011, Bacillus methylotrophicus strain KAS-012, Bacillus methylotrophicus strain KAS-013, and Bacillus methylotrophicus strain KAS-014.

In one embodiment, the present disclosure provides a microbial inoculant composition comprising:
i. dicyandiamide or G77 Nitrification Inhibitor (CAS Registration No. 1373256-33-7); and
ii. at least one Bacillus strain selected from the group consisting of Bacillus subtilis strain KAS-001, Bacillus methylotrophicus strain KAS-002, Bacillus vallismortis strain KAS-003, Bacillus atrophaeus strain KAS-004, Bacillus methylotrophicus strain KAS-005, Bacillus subtilis strain KAS-006, Bacillus amyloliquefasciens strain KAS-007, Bacillus methylotrophicus strain KAS-008, Bacillus subtilis strain KAS-009, Bacillus subtilis strain KAS-010, Bacillus subtilis strain KAS-011, Bacillus methylotrophicus strain KAS-012, Bacillus methylotrophicus strain KAS-013, and Bacillus methylotrophicus strain KAS-014.

G77 is the reaction product of formaldehyde, an ammonia source, and a nitrification inhibitor. For example, G77 can be the reaction product of formaldehyde, urea, DCD, and ammonia. Example G77 structures include:

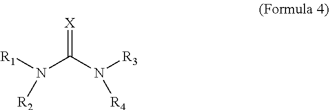

wherein: X is O or

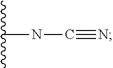 [SMILES: *NC#N]

R₁, R₂, R₃, and R₄ are independently selected from the group consisting of:

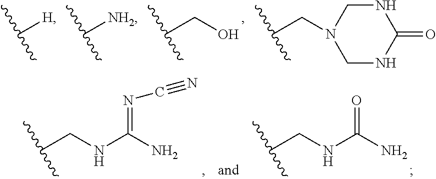

and wherein, if X═O, at least one of R₁, R₂, R₃, and R₄ is

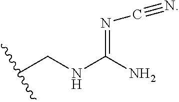 [SMILES: *CN/C(N)=N/C#N]

Another example structure includes:

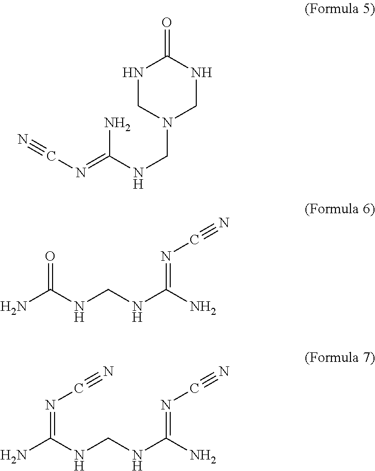 [SMILES: N#C/N=C(\N)NCN1CNC(=O)NC1 ; N#C/N=C(\N)NCNC(N)=O ; N#C/N=C(/N)NCN/C(N)=N/C#N]

The weight percentage of a urease inhibitor such as NBPT in any embodiment of the microbial inoculant composition of the present invention is in the range of 0-80%.

The weight percentage of a nitrification inhibitor such as DCD in any embodiment of the microbial inoculant composition of the present invention is in the range of 0-80%.

In one embodiment of the present invention, the microbial inoculant composition may serve as a fertilizer by itself.

In another embodiment, the present invention provides a fertilizer composition comprising any microbial inoculant composition in any embodiment of the present invention, wherein the fertilize can be granular fertilizers such as urea granular, liquid fertilizers such as urea ammonium nitrate (UAN), an aqueous urea and ammonia nitrate aqueous solution, or anhydrous ammonia (NH₃).

In another embodiment, the present invention provides a method of enhancing a yield trait in a subject plant as compared to the yield trait of a reference or control plant is disclosed, the method comprising contacting an effective amount of a microbial inoculant composition to the reference plant, plant part, plant seed, or surrounding soil, wherein the microbial inoculant composition comprises:
i. at least one microbial strain from one or more microbial species, and
ii. at least one active agent, wherein the active agent is a urease inhibitor, nitrification inhibitor, or a combination thereof,

wherein the microbial inoculant composition at the effective amount is effective in enhancing the yield trait in the subject plant relative to the yield trait in the reference or control plant when the subject plant is contacted with the effective amount.

In another embodiment, the present invention provides a method for enhancing a yield trait in the plant, such as increasing plant growth and/or productivity, wherein the method comprises applying to the plant, plant part, plant seeds or to the soil in which the plant or plant seeds are grown an effective amount of a microbial inoculant composition of any embodiment of the present invention.

In another embodiment, the present invention provides a method for improving soil quality, wherein the method comprises applying to soil or to the plants or plant seeds in said soil an effective amount of a microbial inoculant composition as disclosed in any embodiment of the present invention.

In any embodiment of the invention, the concentrations of each microbial strain to be added to microbial inoculants and fertilizer compositions as disclosed herein will depend on a variety of factors including the identity and number of individual strains employed, the plant species being treated, the nature and condition of the soil to be treated, the exact nature of the microbial inoculant or fertilizer composition to be applied, the type and form of active agent, the form in which the inoculant or fertilizer is applied and the means by which it is applied, and the stage of the plant growing season during which application takes place. For any given case, appropriate concentrations should be effective in enhancing the yield trait in the presence of the active agent, and may be determined by one of ordinary skill in the art using only routine experimentation. By way of example only, the concentration of each strain present in the inoculant or fertilizer composition may be from about 1.0×10² colony forming unis (CFU)/mL to about 5.0×10¹² CFU/mL per acre.

In one embodiment of the present invention, a microbial food source such as kelp or glycerol may be included in any embodiment of the present invention.

The term “microbial species” refers to either naturally occurring or specifically developed variants or mutants of microbial species such as bacteria and fungi as disclosed herein. Variants or mutants may or may not have the same identifying biological characteristics of the specific strains exemplified herein, provided they share similar advantageous properties in terms of promoting plant growth and providing nutrients for plant growth in the soil. Variants of certain microbial strains may include but not limited to gene integration techniques such as those mediated by insertional elements or transposons or by homologous recombination, other recombinant DNA techniques for modifying, inserting, deleting, activating or silencing genes, intraspecific protoplast fusion, mutagenesis by irradiation with ultraviolet light or X-rays, or by treatment with a chemical mutagen such as nitrosoguanidine, methylmethane sulfonate, nitrogen mustard and the like, and bacteriophage-mediated transduction. Suitable and applicable methods are well known in the art and are described, for example, in J. H. Miller, Experiments in Molecular Genetics,

Cold Spring Harbor Laboratory Press, Cold Spring Harbor, N.Y. (1972); J. H. Miller, A Short Course in Bacterial Genetics, Cold Spring Harbor Laboratory Press, Cold Spring Harbor, N.Y. (1992); and J. Sambrook, D. Russell, Molecular Cloning: A Laboratory Manual, 3rd ed., Cold Spring Harbor Laboratory Press, Cold Spring Harbor, N.Y. (2001).

The term “plant productivity” or “yield trait” as used herein refers to any aspect of growth or development of a plant that is a reason for which the plant is grown. Thus, for purposes of the present disclosure, improved or increased “plant productivity” or “enhanced yield trait” refers broadly to improvements in biomass or yield of leaves, stems, grain, fruit, vegetables, flowers, or other plant parts harvested or used for various purposes, and improvements in growth of plant parts, including stems, leaves and roots.

The term “improving soil quality” refers to the increasing the amount and/or availability of nutrients required by, or beneficial to plants, for growth. For example only, such nutrients include nitrogen, phosphorous, potassium, copper, zinc, boron and molybdenum. Also encompassed by the term “improving soil quality” is reducing or minimizing the amount of an element that may be detrimental to plant growth or development such as, for example iron and manganese. Thus, improving soil quality by use of microbial inoculants and fertilizer compositions of the present disclosure thereby assists and promotes the growth of plants in the soil.

The term “effective amount” refers to an amount of microbial inoculant or fertilizer composition applied to a given area of soil or vegetation that is sufficient to promote one or more beneficial or desired outcomes, for example, in terms of plant growth rates, crop yields, or nutrient availability in the soil. An “effective amount” can be provided in one or more administrations. The exact amount required will vary depending on factors such as the identity and number of individual strains employed, the plant species being treated, the nature and condition of the soil to be treated, the exact nature of the microbial inoculant or fertilizer composition to be applied, the form in which the inoculant or fertilizer is applied and the means by which it is applied, and the stage of the plant growing season during which application takes place. For any given case, an appropriate “effective amount” may be determined by one with ordinary skill in the art using only routine experimentation.

The KAS microbial strains described above and used in the below examples have been deposited with the USDA Agricultural Research Service Culture Collection (“NRRL”). Table 1 below correlates the NRRL deposit numbers with the KAS strain numbers.

TABLE 1

| NRRL No. | KAS Strain No. |
|---|---|
| NRRL B-67426 | KAS-001 |
| NRRL B-67427 | KAS-002 |
| NRRL B-67428 | KAS-003 |
| NRRL B-67429 | KAS-004 |
| NRRL B-67430 | KAS-006 |
| NRRL B-67431 | KAS-007 |
| NRRL B-67432 | KAS-008 |
| NRRL B-67433 | KAS-009 |
| NRRL B-67434 | KAS-010 |
| NRRL B-67435 | KAS-011 |
| NRRL B-67436 | KAS-012 |
| NRRL B-67437 | KAS-013 |
| NRRL B-67438 | KAS-014 |

### EXAMPLE 1

### AGROTAIN® ADVANCED 1.0 and Bacillus subtilis Strain KAS-001

Example 1 is prepared by combining 9 mL of AGROTAIN® ADVANCED 1.0 (Koch Agronomic Services, LLC) and 1 mL of proprietary microbial formulation containing Bacillus subtilis strain KAS-001 (Pathway Biologic, LLC). The original bacteria concentration of the microbial formulation is 10¹⁰ cfu/mL. After mixing with the ADVANCED 1.0, the final bacteria concentration is 10⁹ cfu/mL.

Examples 2-10 are prepared with essentially same method as Example 1 (All examples comprise the named bacteria strain and AGROTAIN® ADVANCED 1.0 (1:9 by volume). Only the name of the bacteria strain is provided in Table 1 for each example). If an example with more than one bacteria composition is prepared, the total bacteria concentration of all the microbial formulations is 10¹⁰ cfu/mL. After mixing with the ADVANCED 1.0, the total final bacteria concentration is 10⁹ cfu/mL.

TABLE 2

| Example No. | Bacteria strain and AGROTAIN ® ADVANCED 1.0 (1:9) |
|---|---|
| 2 | Bacillus methylotrophicus strain KAS-002 |
| 3 | Bacillus amyloliquefasciens strain KAS-007 |
| 4 | Bacillus methylotrophicus strain KAS-008 |
| 5 | Bacillus subtilis strain KAS-009 |
| 6 | Bacillus subtilis strain KAS-010 |
| 7 | Bacillus subtilis strain KAS-011 |
| 8 | Bacillus methylotrophicus strain KAS-012 |
| 9 | Bacillus methylotrophicus strain KAS-013 |
| 10 | Bacillus methylotrophicus strain KAS-014 |

### EXAMPLE 11

### G77 Nitrification Inhibitor and Bacillus methylotrophicus KAS-002

Example 11 is prepared by combining 9 mL of G77 Nitrification Inhibitor (CAS Registration No. 1373256-33-7) and 1 mL of proprietary microbial formulation Bacillus methylotrophicus KAS-002 (Pathway Biologic, LLC). The original bacteria concentration of the microbial formulation is 10¹⁰ cfu/mL. After mixing with the G77 Nitrification Inhibitor, the final bacteria concentration is 10⁹cfu/mL.

Examples 12-17 are prepared with essentially same method as Example 11(All examples comprise the named bacteria strain and G77 Nitrification Inhibitor (1:9 by volume). Only the name of the bacteria strain is provided in Table 2 for each example). If an example with more than one bacteria composition is prepared, the total bacteria concentration of all the microbial formulations is 10¹⁰ cfu/mL. After mixing with the G77 Nitrification Inhibitor, the total final bacteria concentration is 10⁹ cfu/mL.

TABLE 3

| | Bacteria strain and G77 Nitrification Inhibitor |
|---|---|
| Example No. | (1:9 by volume) |
| 12 | Bacillus vallismortis KAS-003 |
| 13 | Bacillus atrophaeus KAS-004 |
| 14 | Bacillus subtilis KAS-006 |
| 15 | Bacillus amyloliquefasciens KAS-007 |
| 16 | Bacillus methylotrophicus KAS-008 |
| 17 | Bacillus subtilis KAS-009 |

### Bacteria Strain Capability and Viability Test

The purpose of this test is to evaluate the capability and viability of an individual bacteria strain in a urease inhibitor or a nitrification inhibitor containing solutions.

Aerobic plate counts (APC) are utilized to assess bacterial recovery and survival and to quantify aerobic endospore-forming bacteria (AEFB) in a urease inhibitor or a nitrification inhibitor containing solution as disclosed in Examples 1-17.

Add 10 mL of one of Examples 1-17 (The initial concentration of the bacteria in each Example is 1.0×10¹⁰ spores/mL) to 90 mL of sterile phosphate buffer (pH 7.2) in a 125 mL Erlenmeyer flask and shaken at 150 rpm for 60 minutes. Serial dilutions are made. Prepare 50% TSA medium by dissolving 15 g of Tryptic Soy Broth (half of standard dose) and 18 g of agar in 1 L of sterile water. Plate 100 μL of sample of each concentration onto 50% Tryptic Soy Agar (TSA, DIFCO™). Three replicates are prepared for each Example. Incubate plates for 48 h at 37° C. Numbers of colonies are recorded, and population size is express as spores/mL of each Example.

All the Examples in the present disclosure demonstrate a spore concentration of at least 1.0×10⁸ spores/mL after 48 hours of incubation. For Example 1, which comprises a urease inhibitor and at least one organic solvent, provides a spore concentration of 1.3×10⁹ spores/mL. For Example 11, which comprises a nitrification inhibitor, provides a spore concentration of 7.3×10⁸ spores/mL. The results demonstrate that the exemplified bacteria strains are compatible and viable in the exemplified urease inhibitor or nitrification inhibitor containing organic solvent solutions.

### Bacteria Accelerated Shelf Life Test

The purpose of the accelerated shelf life test is to evaluate the shelf life of individual bacteria strain in a urease inhibitor or a nitrification inhibitor containing solution. The accelerated shelf life is assessed by simulating storage conditions for 18 months at 70% humidity using SPECTRAMAX™ device (model BTL-433).

Place one of Examples 1-17 (10 mL) of the present disclosure in a 50 mL sterile falcon tube. And put the tube inside the device and run the following thermal cycle program (The steps 1-5 in the table represent one thermal cycle):

| Step | Temperature | Time | |
|---|---|---|---|
| 1. Ramp | −20° C. | 20 | minutes |
| 2. Soak | −20° C. | 7 | hours |
| 3. Ramp | 45° C. | 50 | minutes |
| 4. Soak | 45° C. | 17 | hours |
| 5. Ramp | 25° C. | 15 | minutes |

The shelf life of a bacteria strain of one year is represented by 20 thermal cycles. The shelf life of a bacteria strain of 18 months is represented by 30 cycles are representative for 18 months. The humidity level is 70%.

1. A microbial inoculant composition comprising at least one microbial strain from one or more microbial species, and at least one active agent, wherein the active agent is a urease inhibitor or a nitrification inhibitor or a combination thereof, and further wherein the at least one microbial strain is present at an effective amount to promote plant health, plant nutrition, and/or soil health in the presence of the active agent.

2. The microbial inoculant composition according to claim 1 wherein one or more microbial species are selected from the following group consisting of:
(1) Spore forming species of bacteria;
(2) Spore forming species of fungi;
(3) Mycorrhizal organisms including Laccaria bicolor, Glomus intraradices, and Amanita species;
(4) Actinomyces species and strains thereof, including Streptomyces lydicus, Streptomyces griseoviridis, Streptomyces griseoviridis K61 (Mycostop; AgBio development), Streptomyces microflavus AQ 6121;
(5) Bacillus species and strains thereof, including: Bacillus itcheniformis; Bacillus megaterium; Bacillus pumilus, Bacillus amyloliquefaciens, Bacillus licheniformis; Bacillus oleronius; Bacillus megaterium; Bacillus mojavensis; Bacillus pumilus; Bacillus subtilis; Bacillus circulans; Bacillus globisporus; Bacillus firmus, Bacillus thuringiensis, Bacillus cereus, Bacillus amyloliquefaciens strain D747 (Double Nickel; Certis), Bacillus firmus strain 1-1582 (Votivo and Nortica; Bayer), Bacillus licheniformis, Bacillus licheniformis strain SB3086 (Eco Guard; Novozymes), Bacillus pumilus strain GB34 (YieldShield; Bayer), QST2808 (Sonata; Bayer), Bacillus subtilis strains GB03 (Kodiak; Bayer), MBI 600 (Subtilex; Becker Underwood) & QST 713 (Serenade; Bayer), Bacillus subtilis strain GB122 plus Bacillus amyloliquefaciens strain GB99 (Bio Yield; Bayer), Bacillus pumilus strain BUF-33, Bacillus thuringiensis galleriae strain SDS-502, Bacillus thuringiensis kurstaki, VBTS 2546, Bacillus cereus BP01, Bacillus subtilis strain EB120, Bacillus subtilis strain J-P13, Bacillus subtilis FB17, Bacillus subtilis strains QST30002 and QST3004 (NRRL B-50421 and NRRLB-50455), Bacillus subtilis strains QST30002 and QST3004 (NRRL B-50421 and NRRLB-50455) sandpaper mutants, Bacillus thuringiensis subsp kurstaki strain VBTS 2477 quadruple enterotoxindeficient mutants, Bacillus simplex strains 03WN13, 03WN23 and 03WN25, Bacillus subtilis strain QST 713, Bacillus mycoides isolate BmJ NRRL B-30890, Bacillus subtilis strain DSM 17231 and B licheniformis strain DSM17236, Bacillus aryabhattai, B. flexus, B. nealsonii, Bacillus sphaericus, Bacillus megaterium, B. vallismortis;
(6) Species of “Plant Growth Promoting Rhizobacteria” (PGPRs) and strains thereof, including species reported to be capable of Nitrogen fixation, for example Gluconacetobacter species (e.g. Gluconacetobacter diazotrophicus a.k.a. Acetobacter diazotrophicus), Spirillum species (e.g. Spirillum lipoferum), Azospirillum species, Herbaspirillum seropedicae, Azoarcus species, Azotobacter species, Burkholderia species, Burkholderia sp. A396, Paenibacillus polymyxa;
(7) N-fixing bacterial species and strains thereof, including Rhizobium species (e.g. Bradyrhizobium species such as Bradyrhizobium japonicum, Rhizobium meliloti);
(8) Microbial species and strains thereof that are known to improve nutrient use efficiency, including Penicillium species (e.g. Penicillium bilaii, Penicillium bilaji), Mesorhizobium cicero;
(9) Microbial species and strains thereof that are known to have insecticidal or insect repellent effects including Telenomus podisi, Baculovirus anticarsia; Trichogramma pretiosum, Trichogramma galloi, Chromobacterium subtsugae, Trichoderma fertile JM41R, Beauveria bassiana, Beauveria bassiana strain NRRL 30976, Beauveria bassiana strain ATP02, DSM 24665, Paecilomyces fumosoroseus, Trichoderma harzianum, Verticillium lecanii, Isaria fumosorosea CCM 8367 (CCEFO.011.PFR), Lecanicillium muscarium, Streptomyces microflavus, Muscodor albus;
(10) Microbial species and strains thereof that are known to have nematicidal effects e.g. Myrothecium verrucaria, Pasteuria species and strains thereof including Pasteuria nishizawae, Pasteuria Pasteuria reneformis strain Pr-3, Paecilomyces lilacinus, Chromobacterium subtsugae, Pasteuria strain ATCC SD-5832, Metarhizium species, Flavobacterium species;
(11) Microbial species and strains thereof that are known to have antifungal, antimicrobial and/or plant growth promoting effects e.g. Gliocladium species, Pseudomonas species (e.g. Pseudomonas fluorescens, Pseudomonas fluorescens D7, P. putida and P. chlororaphis), Pseudomonas fluorescens strain NRRL B-21133, NRRL B-21053 or NRRL B-21102, Pseudomonas fluorescens VPS, Pseudomonas synxantha, Pseudomonas diazotrophicus, Enterobacter cloacae strain NRRL B-21050, Trichoderma species, Trichoderma virens, Trichoderma atroviride strains, Coniothyrium minitans, Gliocladium species, Gliocladium virens, Gliocladium roseum strain 321U, Trichoderma harzianum species, Trichoderma harzianum Rifai, Clonostachys rosea strain 88-710, Pseudomonas rhodesiae FERM BP-10912, Serratia plymuthica CCGG2742, Cryptococcus lavescens strain OH 182.9, Serratia plymuthica, Cladosporium cladosporioides, Mitsuaria species, Coprinus curtus, Virgibacillus halophilus, Saccharomyces species, Metschnikovia fruticola, Candida oleophila, Acremonium species, Pseudozyma aphidis, Pythium oligandrum, Phoma spp strain 1-4278, Achromobacter species, Geomyces species, Pseudomonas azotoformans, strain F30A, Brevibacillus parabrevis strain No 4; non-toxigenic Aspergillus strains NRRL 50427, NRRL 50428, NRRL 50429, NRRL 50430 and NRRL 50431, Sphaerodes mycoparasitica strains 1DAC 301008-01, -02, or -03, Muscodor albus strain NRRL 30547 or NRRL30548, Serratia plymuthica CCGG2742, Pseudomonas koreensis strain 101L21, P lini strain 131L01, Pantoea agglomerans strain 101L31, Streptomyces scopuliridis strain RB72, Acremonium spp endophytes, Streptomyces spp BG76 strain, Paracoccus kondratievae, Enterobacter cloacae, Cryptococcus flavescens, Lactobacillus parafarraginis, Lactobacillus buchneri, Lactobacillus rapi or Lactobacillus zeae, Paenibacillus polymyxa, Serratia plymuthica, Phoma species, Pythium oligandrum, Mycosphaerella species, Variovorax species;
(12) Bacterial species and strains thereof from the group termed Pink-Pigmented Facultative Methylotrophs (PPFMs) including Methylobacterium species; and
(13) Microbial species and strains thereof that are known to have herbicidal effects e.g. Pyrenophora semeniperda;
wherein the urease inhibitor is selected from a group consisted of N-(n-butyl)thiophosphoric triamide (NBPT), N-(n-butyl)phosphoric triamide, thiophosphoryl triamide, phenyl phosphorodiamidate, cyclohexyl phosphoric triamide, cyclohexyl thiophosphoric triamide, phosphoric triamide, hydroquinone, p-benzoquinone, hexamidocyclotriphosphazene,thiopyridines, thiopyrimidines, thiopyridine-N-oxides, N,N-dihalo-2-imidazolidinone, N-halo-2-oxazolidinone, N-(2-nitrophenyl)thiophosphoric triamide, N-(2-nitrophenyl)phosphoric triamide, derivatives thereof, or any combination thereof; and
wherein the nitrification inhibitor is selected from a group consisted of 2-chloro-6-trichloromethylpyridine, 5-ethoxy-3-trichloromethyl-1,2,4-thiadiazol, dicyandiamide (DCD), 2-amino-4-chloro-6-methyl-pyrimidine, 1,3-benzothyiazole-2-thiol, 4-amino-N-1,3-thiazol-2-ylbenzene sulfonamide, thiourea, guanidine, 3,4-dimethylpyrazole phosphate, 2,4-diamino-6-trichloromethyl-5-triazine, poly etherionophores, 4-amino-1,2,4-triazole, 3-mercapto-1,2,4-triazole, potassium azide, carbon bisulfide, sodium trithiocarbonate, ammonium dithiocarbamate, 2,3-dihydro-2,2-dimethyl-7-benzofuranol methylcarbamate, N-(2,6-dimethylphenyl)-N-(methoxyacetyl)-alanine methyl ester, ammonium thiosulfate, 1-hydroxypyrazole, 3-methylpyrazole-1-carboxamide, 3-methylpyrazole, 3,5-dimethylpyrazole, 1,2,4-triazole, derivatives thereof, and any combination thereof.

3.-14. (canceled)

15. The microbial inoculant composition according to claim 1, wherein the urease inhibitor is N-(n-butyl)thiophosphoric triamide (NBPT).

16. The microbial inoculant composition according to claim 2, wherein the urease inhibitor is NBPT.

17. The microbial inoculant composition according to claim 1, wherein the nitrification inhibitor is dicyandiamide (DCD).

18. The microbial inoculant composition according to claim 2, wherein the nitrification inhibitor is DCD.

19. The microbial inoculant composition according to claim 1, wherein at least one or more microbial species are encapsulated.

20. The microbial inoculant composition according to claim 1, for use as a fertilizer.

21. A fertilizer composition comprising a microbial inoculant composition according to claim 1.

22. A fertilizer composition according to claim 21 for use in fertilizing pasture plants, crop plants, or ornamental plants.

23. A method for increasing plant growth and/or productivity, the method comprising applying to a plant, plant part, plant seed or to a soil in which the plant or plant seeds are grown an effective amount of a microbial inoculant composition according to claim 1 or a fertilizer composition comprising the microbial inoculant composition according to claim 1.

24. A method for improving soil quality, the method comprising applying to soil or to a plant, plant part or plant seed in the soil an effective amount of a microbial inoculant composition according to claim 1 or a fertilizer composition comprising the microbial inoculant composition according to claim 1.

25. A method of enhancing a yield trait in a subject plant as compared to the yield trait of a reference or control plant, the method comprising contacting an effective amount of a microbial inoculant composition to the reference plant, plant part, plant seed, or surrounding soil, wherein the microbial inoculant composition comprises:
i. at least one microbial strain from one or more microbial species, and
ii. at least one active agent, wherein the active agent is a urease inhibitor, nitrification inhibitor, or a combination thereof,
wherein the microbial inoculant composition at the effective amount is effective in enhancing the yield trait in the subject plant relative to the yield trait in the reference or control plant when the subject plant is contacted with the effective amount.

26. The microbial inoculant composition according to claim 1, wherein the nitrification inhibitor is a reaction product of formaldehyde, DCD, urea, and ammonia.

27. The microbial inoculant composition according to claim 26, wherein the nitrification inhibitor has the following structure: 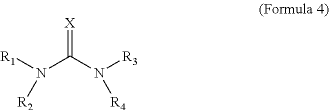
wherein: X is O or 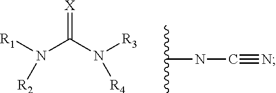
R1, R2, R3, and R4 are independently selected from the group consisting of: 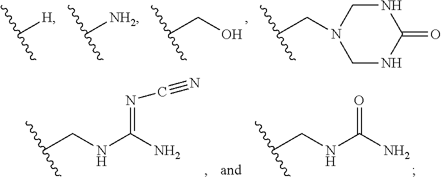
and wherein, if X═O, at least one of R1, R2, R3, and R4 is

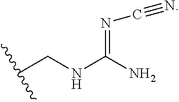 [SMILES: *CN/C(N)=N/C#N]

28. The microbial inoculant composition according to claim 26, wherein the nitrification inhibitor has one or more of the following structures:

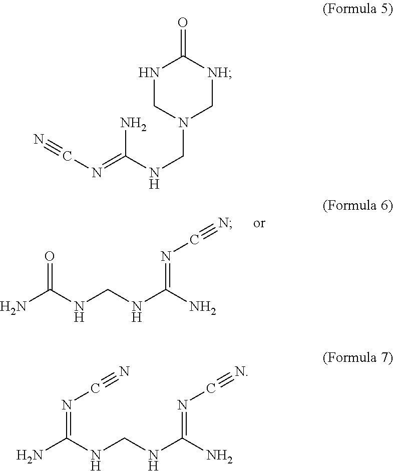 [SMILES: N#C/N=C(\N)NCN1CNC(=O)NC1 ; N#C/N=C(\N)NCNC(N)=O ; N#C/N=C(/N)NCN/C(N)=N/C#N]

29. The microbial inoculant composition according to claim 2, wherein the nitrification inhibitor is a reaction product of formaldehyde, DCD, urea, and ammonia.

30. The microbial inoculant composition according to claim 29, wherein the nitrification inhibitor has the following structure: 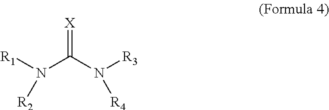
wherein: X is O or 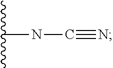 [SMILES: *NC#N]
R1, R2, R3, and R4 are independently selected from the group consisting of: 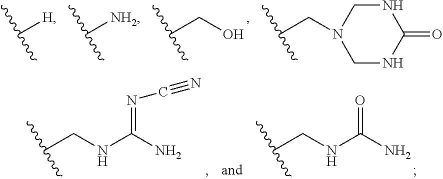
and wherein, if X=O, at least one of R1, R2, R3, and R4 is

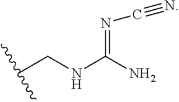 [SMILES: *CN/C(N)=N/C#N]

31. The microbial inoculant composition according to claim 29, wherein the nitrification inhibitor has one or more of the following structures: 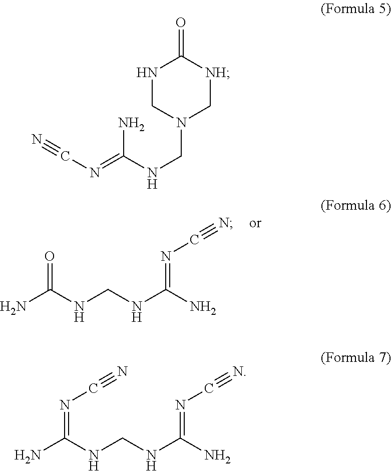 [SMILES: N#C/N=C(\N)NCN1CNC(=O)NC1 ; N#C/N=C(\N)NCNC(N)=O ; N#C/N=C(/N)NCN/C(N)=N/C#N]
